(19) United States
(12) Patent Application Publication
(10) Pub. No.: US 2022/0316481 A1
(43) Pub. Date: Oct. 6, 2022

(54) PUMP APPARATUS

(71) Applicant: EBARA CORPORATION, Tokyo (JP)

(72) Inventors: Kazuya HIRAMOTO, Tokyo (JP); Miho ISONO, Tokyo (JP); Takahiko OGAWA, Tokyo (JP)

(21) Appl. No.: 17/636,912

(22) PCT Filed: Aug. 28, 2020
(86) PCT No.: PCT/JP2020/032649

§ 371 Date: Feb. 21, 2022

(30) Foreign Application Priority Data
Aug. 29, 2019 (JP) 2019-156400

(51) Int. Cl. F04D 15/00; F04D 13/08

(52) U.S. Cl. CPC F04D 15/0066; F04D 15/0077; F04D 13/08; F05D 2210/11

(57) ABSTRACT

The application relates to a pump apparatus for pumping liquid, and more particularly to a technique for removing foreign matters contained in the liquid when an impeller catches on the foreign matters. The pump apparatus includes: an impeller (1); an electric motor (7) configured to rotate the impeller (1); an inverter (14) configured to drive the electric motor (7); a current measuring device (15) configured to measure a current supplied to the electric motor (7); and an operation controller (17) configured to instruct the inverter (14) to cause the impeller (1) to perform a foreign-matter removing operation including at least two of: an intermittent operation that intermittently rotates the impeller (1) in a forward direction; a reverse-rotating operation that rotates the impeller (1) in a reverse direction; and a forward and reverse inching operation that rotates the impeller (1) in the reverse direction and the forward direction alternately and repeatedly.

### TECHNICAL FIELD

The present invention relates to a pump apparatus for pumping a liquid, and more particularly to a technique for removing foreign matters contained in the liquid when an impeller catches on the foreign matters.

### BACKGROUND ART

A drainage pump, such as a submersible pump, is sometimes used to pump up river water or wastewater discharged from buildings, such as commercial buildings. Water often contains foreign matters, such as solids or fibers. When the drainage pump is pumping such water, an impeller of the drainage pump may catch on a foreign matter and as a result, the pumping operation may be hindered. Therefore, in order to remove such foreign matter, a technique has been proposed to detect the catching of the foreign matter based on an electric current supplied to a motor that drives the impeller and to remove the foreign matter by rotating the impeller in a reverse direction. (see patent document 1).

### CITATION LIST

### Patent Literature

Patent document 1: Japanese laid-open patent publication No. 2004-308555
Patent document 2: Japanese laid-open patent publication No. H11-107975
Patent document 3: Japanese laid-open patent publication No. 2018-119310

### SUMMARY OF INVENTION

### Technical Problem

However, the conventional method using the reverse rotating operation may fail to remove the foreign matter. As a result, it is necessary to stop the operation of the pump and manually remove the foreign matter by a worker. Such removing work is not only time-consuming, but also entails a long downtime of the pump.

Therefore, the present invention provides a pump apparatus capable of reliably removing foreign matter caught by an impeller.

### Solution to Problem

In one embodiment, there is provided a pump apparatus comprising: an impeller; an electric motor configured to rotate the impeller; an inverter configured to drive the electric motor; a current measuring device configured to measure a current supplied to the electric motor; and an operation controller configured to instruct the inverter to cause the impeller to perform a foreign-matter removing operation, the foreign-matter removing operation including at least two of: an intermittent operation that intermittently rotates the impeller in a forward direction; a reverse-rotating operation that rotates the impeller in a reverse direction; and a forward and reverse inching operation that rotates the impeller in the reverse direction and the forward direction alternately and repeatedly.

In one embodiment, the foreign-matter removing operation includes the intermittent operation and the reverse-rotating operation, and the operation controller is configured to cause the impeller to perform the intermittent operation and the reverse-rotating operation in the order of the intermittent operation and the reverse-rotating operation.

In one embodiment, the foreign-matter removing operation includes the reverse-rotating operation; and the reverse-rotating operation includes a first reverse-rotating operation that rotates the impeller in the reverse direction in a first acceleration pattern and a second reverse-rotating operation that rotates the impeller in the reverse direction in a second acceleration pattern.

In one embodiment, the operation controller is configured to cause the impeller to perform the second reverse-rotating operation when a measured value of the current in the first reverse-rotating operation exceeds a threshold value.

In one embodiment, the first acceleration pattern is an acceleration pattern for speeding up the impeller at a constant acceleration, and the second acceleration pattern is an acceleration pattern for speeding up the impeller while changing an acceleration of the impeller.

In one embodiment, there is provided a pump apparatus comprising: an impeller; an electric motor configured to rotate the impeller; an inverter configured to drive the electric motor; a current measuring device configured to measure a current supplied to the electric motor; and an operation controller configured to instruct the inverter to cause the impeller to perform a foreign-matter removing operation, the foreign-matter removing operation including a first reverse-rotating operation that rotates the impeller in a reverse direction in a first acceleration pattern and a second reverse-rotating operation that rotates the impeller in the reverse direction in a second acceleration pattern.

In one embodiment, the operation controller is configured to cause the impeller to perform the second reverse-rotating operation when a measured value of the current in the first reverse-rotating operation exceeds a threshold value.

In one embodiment, the first acceleration pattern is an acceleration pattern for speeding up the impeller at a constant acceleration, and the second acceleration pattern is an acceleration pattern for speeding up the impeller while changing an acceleration of the impeller.

### Advantageous Effects of Invention

According to the present invention, a foreign matter caught by the impeller can be reliably removed by the combination of the plurality of different operations of the impeller (for example, the combination of the intermittent operation and the reverse-rotating operation, or the combination of the first reverse-rotating operation and the second reverse-rotating operation).

### BRIEF DESCRIPTION OF DRAWINGS

FIG. 1 is a cross-sectional view showing an embodiment of a pump apparatus;

FIG. 2 is a flowchart showing an embodiment of a foreign-matter removing operation;

FIG. 3 is a flowchart showing another embodiment of the foreign-matter removing operation;

FIG. 4 is a flowchart showing still another embodiment of the foreign-matter removing operation;

FIG. 5 is a flowchart showing still another embodiment of the foreign-matter removing operation; and

FIG. 6 is a flowchart showing still another embodiment of the foreign-matter removing operation.

### DESCRIPTION OF EMBODIMENTS

Hereinafter, embodiments of the present invention will be described with reference to the drawings.

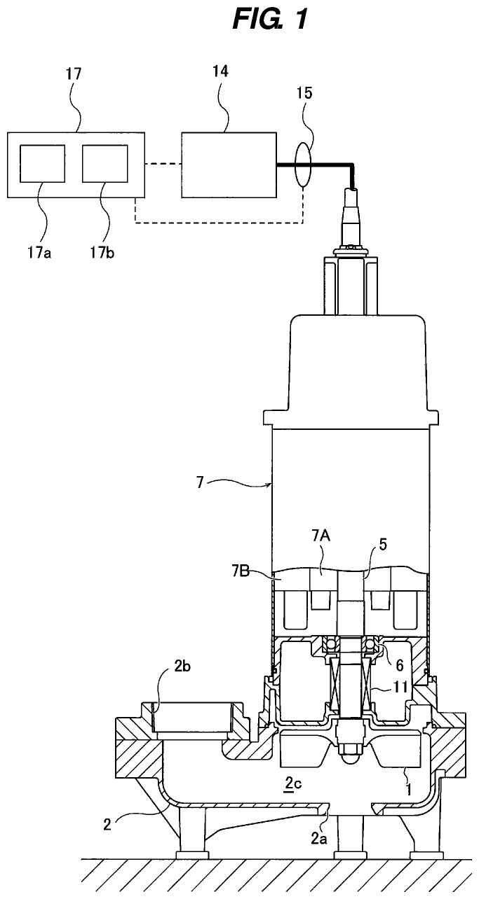

FIG. 1 is a cross-sectional view showing an embodiment of a pump apparatus. As shown in FIG. 1, the pump apparatus includes an impeller 1, a pump casing 2 in which the impeller 1 is housed, a rotating shaft 5 to which the impeller 1 is fixed, and an electric motor 7 for rotating the impeller 1. The electric motor 7 has a motor rotor 7A fixed to the rotating shaft 5, and a motor stator 7B surrounding the motor rotor 7A. The rotating shaft 5 is rotatably supported by a bearing 6. In this embodiment, the rotating shaft 5 is a single shaft extending from the electric motor 7 to the impeller 1. In one embodiment, the rotating shaft 5 may be divided into a drive shaft to which the motor rotor 7A of the electric motor 7 is fixed and a pump shaft to which the impeller 1 is fixed. In this case, the drive shaft and the pump shaft are coupled by a coupling element.

The pump casing 2 has a suction port 2a for liquid, a discharge port 2b for liquid, and a volute chamber 2c. The impeller 1 is arranged in the volute chamber 2c. A gap between the pump casing 2 and the rotating shaft 5 is sealed by a shaft sealing device 11 (e.g., a mechanical seal or a gland packing).

The pump apparatus further includes an inverter 14 for driving the electric motor 7, a current measuring device 15 for measuring electric current supplied to the electric motor 7, and an operation controller 17 for controlling operations of the inverter 14. In FIG. 1, the inverter 14 and the current measuring device 15 are schematically depicted. In the embodiment shown in FIG. 1, the inverter 14 and the current measuring device 15 are provided separately from the electric motor 7, but the inverter 14 and the current measuring device 15 may be integrated with the electric motor 7. Further, the inverter 14 and the operation controller 17 may be integrated. The current measuring device 15 is arranged so as to measure the electric current supplied from the inverter 14 to the electric motor 7. The current measuring device 15 may be incorporated in the inverter 14. The current measuring device 15 is coupled to the operation controller 17, and is configured to transmit a measured value of the current to the operation controller 17.

The operation controller 17 includes a memory 17a storing therein programs for causing the impeller 1 to perform a foreign-matter removing operation described later, and a processor 17b configured to perform arithmetic operations according to instructions included in the programs. The memory 17a includes a main memory, such as a RAM, and an auxiliary memory, such as a hard disk drive (HDD) or a solid state drive (SSD). Examples of the processor 17b include a CPU (central processing unit) and a GPU (graphic processing unit).

The operation of the pump apparatus is as follows. The operation controller 17 gives a speed command to the inverter 14, which in turn generates electric current having a frequency corresponding to the given speed command. The generated current is supplied to the electric motor 7, which rotates the impeller 1. The current measuring device 15 measures the current supplied to the electric motor 7. As the impeller 1 rotates, the liquid flows into the volute chamber 2c through the suction port 2a, is pressurized in the volute chamber 2c, and is discharged through the discharge port 2b.

A submersible motor having a liquid-tight structure is adopted for the electric motor 7. Therefore, the pump apparatus of the present embodiment is a submersible-motor pump apparatus that can operate while the pump apparatus is immersed in a liquid. Generally, the submersible-motor pump apparatus is often used for pumping a liquid containing foreign matters, such as solids or fibers. If the impeller 1 catches on the foreign matters during the operation of the pump apparatus, the rotation of the impeller 1 may be hindered. Thus, the operation controller 17 is configured to instruct the inverter 14 to cause the impeller 1 to perform the foreign-matter removing operation.

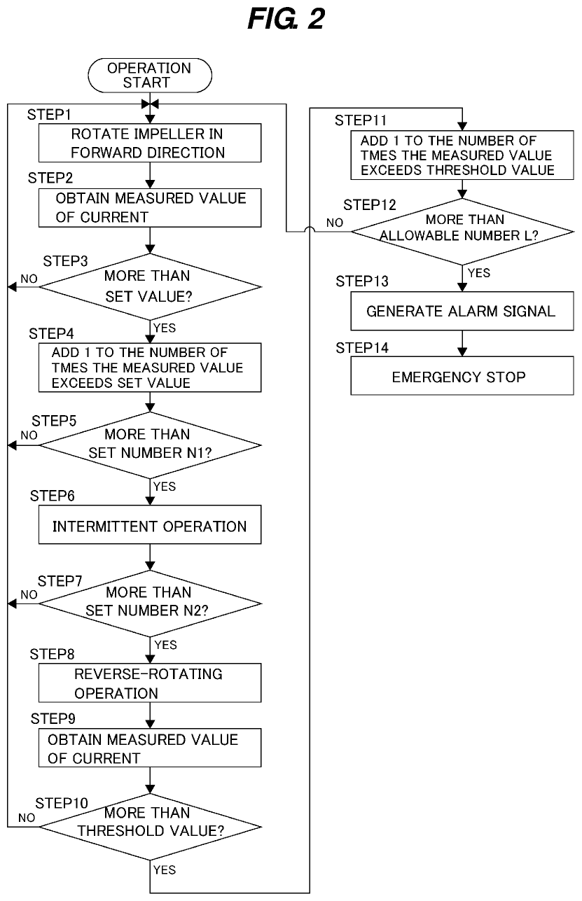

FIG. 2 is a flowchart showing an embodiment of the foreign-matter removing operation. In this embodiment, the foreign-matter removing operation includes an intermittent operation in which the impeller 1 is intermittently rotated in a forward direction and a reverse-rotating operation in which the impeller 1 is rotated in an reverse direction.

In step 1, the operation controller 17 instructs the inverter 14 to rotate the impeller 1 in the forward direction. The rotation of the impeller 1 in the forward rotation is an normal operation of the pump apparatus and can pump the liquid.

In step 2, the current measuring device 15 measures the current supplied from the inverter 14 to the electric motor 7, and the operation controller 17 obtains the measured value of the current from the current measuring device 15. The inverter 14 is configured to supply to the electric motor 7 a current having a frequency corresponding to a speed command given by the operation controller 17. If the impeller 1 catches on a foreign matter contained in the liquid, a load applied to the electric motor 7 increases, and as a result, the current supplied to the electric motor 7 (i.e., a magnitude of the current expressed in ampere) increases.

Therefore, in step 3, the operation controller 17 compares the measured value of the current with a set value. If the measured value of the current is smaller than the set value, the operation flow goes back to the step 1.

In step 4, if the measured value of the current is larger than the set value, the operation controller 17 adds 1 to the number of times the measured value of the current exceeds the set value.

In step 5, the operation controller 17 compares the number of times the measured value of the current exceeds the set value with a preset number of times N1. The purpose of this step 5 is to distinguish the current increase due to the foreign matter caught by the impeller from malfunction and current noise. If the number of times the measured value of the current exceeds the set value is smaller than the preset number of times N1, the operation flow goes back to the step 1.

If the number of times the measured value of the current exceeds the set value is larger than the preset number of times N1, the operation controller 17 instructs the inverter 14 to cause the impeller 1 to perform the intermittent operation. The intermittent operation of the impeller 1 is an operation in which the impeller 1 rotates in the forward direction and stops its rotation repeatedly. The intermittent operation is performed for a preset period of time. The intermittent operation of the impeller 1 is performed for the purpose of removing the foreign matter. Specifically, when the rotation of the impeller 1 in the forward direction is stopped, a part of the liquid that has been once pumped up flows back into the pump casing 2. During the intermittent operation, such pumping up of the liquid and the backward flow of the liquid are repeated, so that the flow of the liquid pulsates to remove the foreign matter.

In step 7, the operation controller 17 compares the number of times the measured value of the current exceeds the set value with a preset number of times N2. The preset number of times N2 is a numerical value larger than the preset number of times N1 in the step 5. If the number of times the measured value of the current exceeds the set value is smaller than the preset number of times N2, the operation flow goes back to the step 1.

In step 8, if the number of times the measured value of the current exceeds the set value is larger than the preset number of times N2, the operation controller 17 instructs the inverter 14 to cause the impeller 1 to perform the reverse-rotating operation. This reverse-rotating operation is an operation in which the impeller 1 is rotated in the reverse direction. The reverse-rotating operation of the impeller 1 is performed for the purpose of removing the foreign matter. Specifically, rotating the impeller 1 in the reverse direction makes it possible to remove the foreign matter caught by the impeller 1.

Examples of an acceleration pattern at the start of the reverse-rotating operation include a pattern in which the impeller 1 is speeded up at a constant acceleration, and a pattern in which the impeller 1 is speeded up to a set speed while changing the acceleration of the impeller 1. In particular, the acceleration pattern that speeds up the impeller 1 while changing the acceleration of the impeller 1 can form an irregular flow of the liquid in the volute chamber 2c, which makes it easier to remove the foreign matter. The acceleration pattern that changes the acceleration of the impeller 1 may include a period during which the speed of the impeller 1 is temporarily zero. For example, the rotation of the impeller 1 may be stopped momentarily when the impeller 1 is rotated at accelerations in an S-shaped curve.

In step 9, the current measuring device 15 measures the current supplied to the electric motor 7 when the impeller 1 is performing the reverse-rotating operation, and the operation controller 17 obtains the measured value of the current from the current measuring device 15.

In step 10, the operation controller 17 compares the measured value of the current in the reverse-rotating operation with a threshold value. If the measured current is smaller than the threshold value, the operation flow goes back to the step 1.

In step 11, if the measured value of the current is larger than the threshold value, the operation controller 17 adds 1 to the number of times the measured value of the current in the reverse-rotating operation exceeds the threshold value.

In step 12, the operation controller 17 compares the number of times the measured value of the current in the reverse-rotating operation exceeds the threshold value with a preset allowable number L. If the number of times the measured value of the current in the reverse-rotating operation exceeds the threshold value is smaller than the preset allowable number L, the operation flow goes back to the step 1.

In step 13, if the number of times the measured value of the current in the reverse-rotating operation exceeds the threshold value is larger than the preset allowable number L, the operation controller 17 generates an alarm signal, and transmits the alarm signal to an alarm device, such as a rotating light, a buzzer, a display device, or the like. The operation controller 17 may transmit the alarm signal to a predetermined contact (for example, an administrator).

In step 14, the operation controller 17 instructs the inverter 14 to stop the electric motor 7. As a result, the operation of the pump apparatus is brought into an emergency stop.

According to the present embodiment, the foreign matter caught by the impeller 1 can be removed by the combination of the intermittent operation and the reverse-rotating operation. Therefore, the emergency stop of the pump apparatus is avoided, and the pump apparatus can continue its pumping operation.

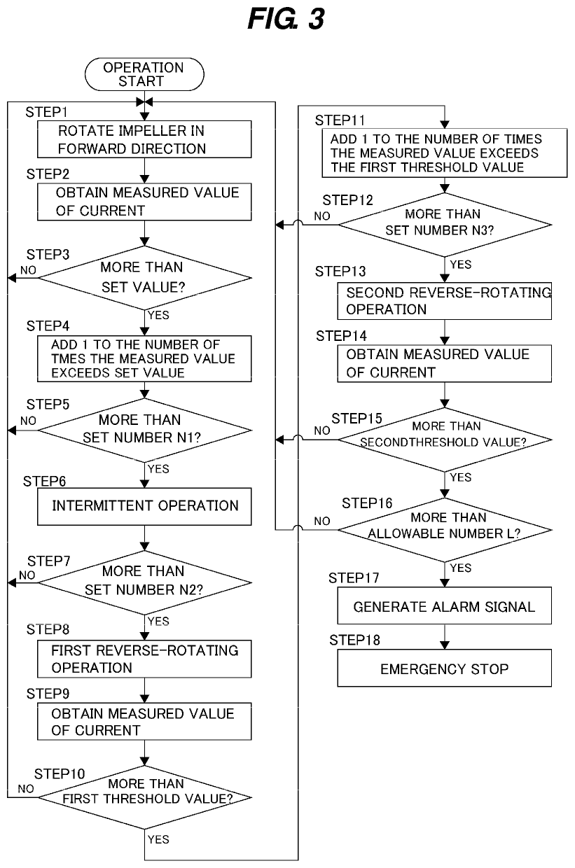

FIG. 3 is a flowchart showing another embodiment of the foreign-matter removing operation. In this embodiment, the foreign-matter removing operation includes the intermittent operation in which the impeller 1 is intermittently rotated in the forward direction, and a first reverse-rotating operation and a second reverse-rotating operation in which the impeller 1 is rotated in the reverse direction. In the flowchart shown in FIG. 3, steps 1 to 7 are the same as the steps 1 to 7 in the flowchart shown in FIG. 2, and duplicate descriptions thereof will be omitted.

In step 8, the operation controller 17 instructs the inverter 14 to cause the impeller 1 to perform the first reverse-rotating operation. This first reverse-rotating operation is an operation in which the impeller 1 is rotated in the reverse direction with a first acceleration pattern. The first acceleration pattern is a pattern in which the impeller 1 is speeded up to a first set speed at a constant acceleration.

In step 9, the current measuring device 15 measures the current supplied to the electric motor 7 when the impeller 1 is in the first reverse-rotating operation, and the operation controller 17 obtains the measured value of the current from the current measuring device 15.

In step 10, the operation controller 17 compares the measured value of the current in the first reverse-rotating operation with a first threshold value. If the measured value of the current is smaller than the first threshold value, the operation flow goes back to the step 1.

In step 11, if the measured value of the current is larger than the first threshold value, the operation controller 17 adds 1 to the number of times the measured value of the current in the first reverse-rotating operation exceeds the first threshold value. In step 12, the operation controller 17 compares the number of times the measured value of the current in the first reverse-rotating operation exceeds the first threshold value with a preset number of times N3. If the number of times the measured value of the current in the first reverse-rotating operation exceeds the first threshold value is smaller than the preset number of times N3, the operation flow goes back to the step 1.

In step 13, if the number of times the measured value of the current in the first reverse-rotating operation exceeds the first threshold value is larger than the preset number of times N3, the operation controller 17 instructs the inverter 14 to cause the impeller 1 to perform the second reverse-rotating operation. This second reverse-rotating operation is an operation in which the impeller 1 is rotated in the reverse direction with a second acceleration pattern. The second reverse-rotating operation is performed after the reverse rotation of the impeller 1 is slowed down or stopped.

The second acceleration pattern is different from the first acceleration pattern in the first reverse-rotating operation. More specifically, the second acceleration pattern is a pattern in which the impeller 1 is speeded up to a second set speed while changing the acceleration of the impeller 1. The second acceleration pattern is, for example, an acceleration pattern in an S-shaped curve. The second acceleration pattern may include a period during which the speed of the impeller 1 is temporarily zero. For example, the rotation of the impeller 1 may be stopped momentarily when the impeller 1 is rotated at accelerations in an S-shaped curve. The second set speed may be the same as or different from the first set speed in the first reverse-rotating operation.

When the impeller 1 is rotated while the acceleration of the impeller 1 is being changed, the liquid forms non-uniform flow, which can easily remove the foreign matter. According to the present embodiment, the combination of the intermittent operation, the first reverse-rotating operation, and the second reverse-rotating operation can remove the foreign matter caught by the impeller 1. Therefore, the emergency stop of the pump apparatus is avoided, and the pump apparatus can continue its pumping operation.

In step 14, the current measuring device 15 measures the current supplied to the electric motor 7 when the impeller 1 is in the second reverse-rotating operation, and the operation controller 17 obtains the measured value of the current from the current measuring device 15.

In step 15, the operation controller 17 compares the measured value of the current in the second reverse-rotating operation with a second threshold value. If the measured value of the current is smaller than the second threshold value, the operation flow goes back to the step 1.

In step 16, if the measured value of the current is larger than the second threshold value, the operation controller 17 compares the number of times the measured value of the current in the second reverse-rotating operation exceeds the second threshold value with the preset allowable number L. If the number of times the measured value of the current in the second reverse-rotating operation exceeds the second threshold value is smaller than the preset allowable number L, the operation flow goes back to the step 1.

In step 17, if the number of times the measured value of the current in the second reverse-rotating operation exceeds the second threshold value is larger than the preset allowable number L, the operation controller 17 generates an alarm signal, and transmits the alarm signal to an alarm device, such as a rotating light, a buzzer, a display device, or the like. The operation controller 17 may transmit the alarm signal to a predetermined contact (for example, an administrator).

In step 18, the operation controller 17 instructs the inverter 14 to stop the electric motor 7. As a result, the operation of the pump apparatus is brought into an emergency stop.

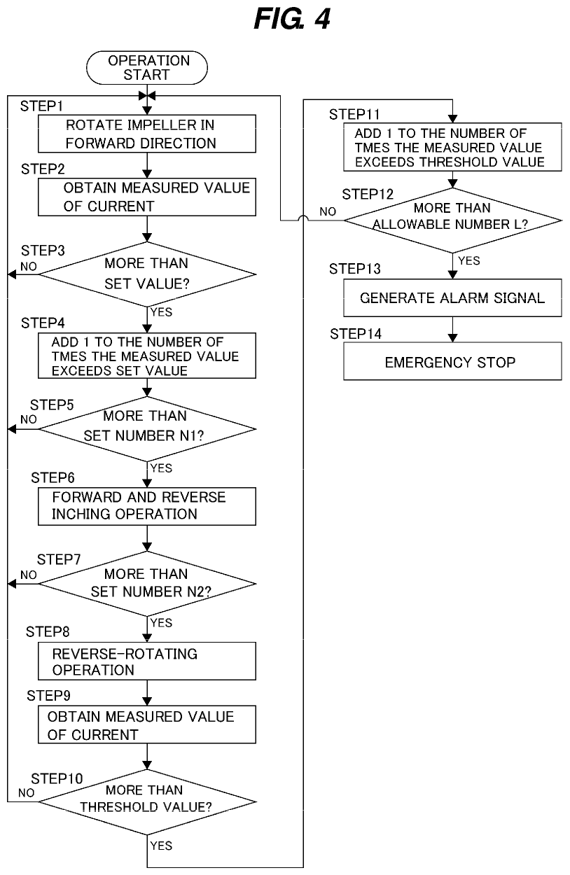

FIG. 4 is a flowchart showing still another embodiment of the foreign-matter removing operation. In this embodiment, the foreign-matter removing operation includes a forward and reverse inching operation and the reverse-rotating operation. The intermittent operation is not included in the foreign-matter removing operation of this embodiment. The flowchart shown in FIG. 4 is the same as the flowchart shown in FIG. 2 except for the forward and reverse inching operation in step 6, and therefore repetitive descriptions will be omitted.

The forward and reverse inching operation is an operation in which the impeller 1 is repeatedly rotated in the reverse direction and the forward direction alternately. Specifically, the operation controller 17 instructs the inverter 14 to switch the polarity of the current supplied to the electric motor 7 in a short cycle, so that the electric motor 7 rotates the impeller 1 in the reverse direction and the forward direction alternately and repeatedly. The impeller 1 can jiggle (or move with quick motions) to thereby remove the foreign matter caught by the impeller 1. In one embodiment, the foreign-matter removing operation may further include the intermittent operation. For example, the operation controller 17 may instruct the inverter 14 to cause the impeller 1 to perform the intermittent operation, the forward and reverse inching operation, and the reverse-rotating operation in the order of the intermittent operation, the forward and reverse inching operation, and the reverse-rotating operation. Further, in one embodiment, the foreign-matter removing operation may include the intermittent operation and the forward and reverse inching operation, and may not include the reverse-rotating operation.

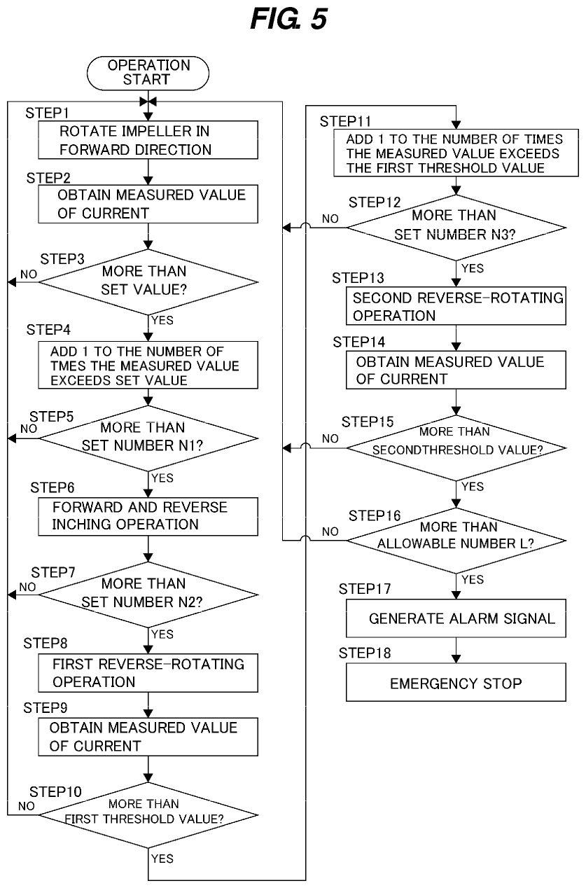

FIG. 5 is a flowchart showing still another embodiment of the foreign-matter removing operation. In this embodiment, the foreign-matter removing operation includes the forward and reverse inching operation, the first reverse-rotating operation, and the second reverse-rotating operation. The intermittent operation is not included in the foreign-matter removing operation of this embodiment. Since the flowchart shown in FIG. 5 is the same as the flowchart shown in FIG. 3 except for the forward and reverse inching operation in step 6, the repetitive descriptions will be omitted.

In one embodiment, the foreign-matter removing operation may further include the intermittent operation. For example, the operation controller 17 may instruct the inverter 14 to cause the impeller 1 to perform the intermittent operation, the forward and reverse inching operation, the first reverse-rotating operation, and the second reverse-rotating operation in the order of the intermittent operation, the forward and reverse inching operation, the first reverse-rotating operation, and the second reverse-rotating operation.

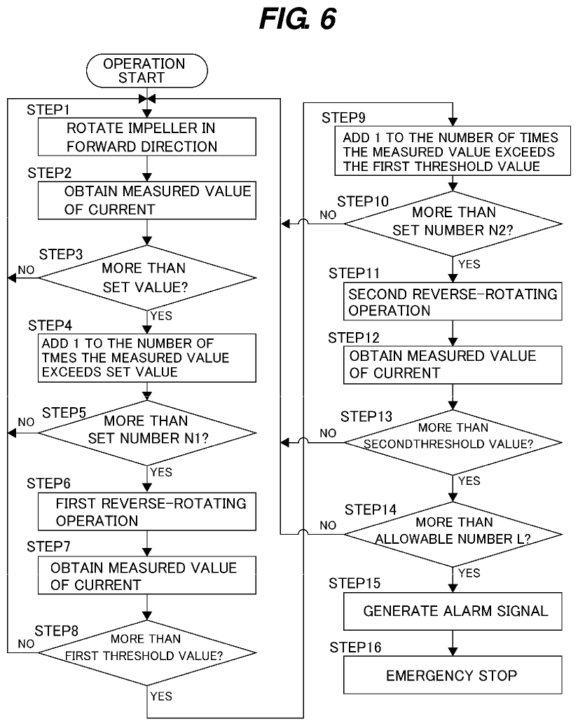

FIG. 6 is a flowchart showing still another embodiment of the foreign-matter removing operation. In this embodiment, the foreign-matter removing operation includes the first reverse-rotating operation and the second reverse-rotating operation. The intermittent operation and the forward and reverse inching operation are not included in the foreign-matter removing operation of this embodiment. Since steps 1 to 5 of the flowchart shown in FIG. 6 are the same as the steps 1 to 5 of the flowchart shown in FIG. 2, the repetitive descriptions will be omitted.

In step 6, if the number of times the measured value of the current exceeds set value is larger than preset number of times N1, the operation controller 17 instructs the inverter 14 to cause the impeller 1 to perform the first reverse-rotating operation. This first reverse-rotating operation is an operation in which the impeller 1 is rotated in the reverse direction in first acceleration pattern. The first acceleration pattern is a pattern in which the impeller 1 is speeded up to first set speed at a constant acceleration.

In step 7, the current measuring device 15 measures the current supplied to the electric motor 7 when the impeller 1 is in the first reverse-rotating operation, and the operation controller 17 obtains the measured value of the current from the current measuring device 15.

In step 8, the operation controller 17 compares the measured value of the current in the first reverse-rotating operation with first threshold value. If the measured value of the current is smaller than the first threshold value, the operation flow goes back to the step 1.

In step 9, if the measured value of the current is larger than the first threshold value, the operation controller 17 adds 1 to the number of times the measured value of the current in the first reverse-rotating operation exceeds the first threshold value.

In step 10, the operation controller 17 compares the number of times the measured value of the current in the first reverse-rotating operation exceeds the first threshold value with preset number of times N2. If the number of times the measured value of the current in the first reverse-rotating operation exceeds the first threshold value is smaller than the preset number of times N2, the operation flow goes back to the step 1.

In step 11, if the number of times the measured value of the current in the first reverse-rotating operation exceeds the first threshold value is larger than the preset number of times N2, the operation controller 17 instructs the inverter 14 to cause the impeller 1 to perform the second reverse-rotating operation. This second reverse-rotating operation is an operation in which the impeller 1 is rotated in the reverse direction in second acceleration pattern. The second reverse-rotating operation is performed after the reverse rotation of the impeller 1 is slowed down or stopped.

The second acceleration pattern is different from the first acceleration pattern in the first reverse-rotating operation. More specifically, the second acceleration pattern is a pattern in which the impeller 1 is speeded up to second set speed while changing the acceleration of the impeller 1. The second acceleration pattern is, for example, an acceleration pattern in an S-shaped curve. The second acceleration pattern may include a period during which the speed of the impeller 1 is temporarily zero. For example, the rotation of the impeller 1 may be stopped momentarily while the impeller 1 is rotated at accelerations in an S-shaped curve. The second set speed may be the same as or different from the first set speed in the first reverse-rotating operation.

When the impeller 1 is rotated while the acceleration of the impeller 1 is being changed, the liquid forms non-uniform flow, which can easily remove the foreign matter. According to the present embodiment, the combination of the first reverse-rotating operation and the second reverse-rotating operation can remove the foreign matter caught by the impeller 1. Therefore, the emergency stop of the pump apparatus is avoided, and the pump apparatus can continue its pumping operation.

In step 12, the current measuring device 15 measures the current supplied to the electric motor 7 when the impeller 1 is in the second reverse-rotating operation, and the operation controller 17 obtains the measured value of the current from the current measuring device 15.

In step 13, the operation controller 17 compares the measured value of the current in the second reverse-rotating operation with second threshold value. If the measured value of the current is smaller than the second threshold value, the operation flow goes back to the step 1.

In step 14, if the measured value of the current is larger than the second threshold value, the operation controller 17 compares the number of times the measured value of the current in the second reverse-rotating operation exceeds the second threshold value with preset allowable number L. If the number of times the measured value of the current in the second reverse-rotating operation exceeds the second threshold value is smaller than the preset allowable number L, the operation flow goes back to the step 1.

In step 15, if the number of times the measured value of the current in the second reverse-rotating operation exceeds the second threshold value is larger than the preset allowable number L, the operation controller 17 generates an alarm signal, and transmits the alarm signal to an alarm device, such as a rotating light, a buzzer, a display device, or the like. The operation controller 17 may transmit the alarm signal to a predetermined contact (for example, an administrator).

In step 16, the operation controller 17 instructs the inverter 14 to stop the electric motor 7. As a result, the operation of the pump apparatus is brought into an emergency stop.

In the above-described embodiments shown in FIGS. 2 to 6, the number of times to be compared with the set number of times N1, N2, N3 and the allowable number of times L is reset to 0 under a predetermined condition. Specifically, when a preset time (including an operation stop time) has elapsed, or when a total operation time of the step 1 exceeds a preset time, or when the number of operations of the step 1 exceeds a preset value, the number of times to be compared with the set number of times N1, N2, N3 and the allowable number of times L is reset to 0.

The pump apparatus according to each of the above-described embodiments is a submersible motor pump apparatus that can operate in a liquid. The foreign matter may be caught in other types of pump than the submersible motor pump apparatus. Therefore, the present invention is not limited to the present embodiments, and can be applied to other types of pump apparatus, such as a land-based pump apparatus which is used on land.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

### INDUSTRIAL APPLICABILITY

The present invention can be applied to a pump apparatus for pumping a liquid, and more particularly to a technique for removing foreign matters contained in the liquid when an impeller catches on the foreign matters.

### REFERENCE SIGNS LIST

1 impeller
2 pump casing
2a suction port
2b discharge port
2c volute chamber
5 rotating shaft
6 bearing
7 electric motor
11 shaft sealing device
14 inverter
15 current measuring device
17 operation controller

What is claimed is:

1. A pump apparatus comprising:
an impeller;
an electric motor configured to rotate the impeller;
an inverter configured to drive the electric motor;
a current measuring device configured to measure a current supplied to the electric motor; and
an operation controller configured to instruct the inverter to cause the impeller to perform a foreign-matter removing operation, the foreign-matter removing operation including at least two of:
an intermittent operation that intermittently rotates the impeller in a forward direction;
a reverse-rotating operation that rotates the impeller in a reverse direction; and
a forward and reverse inching operation that rotates the impeller in the reverse direction and the forward direction alternately and repeatedly.

2. The pump apparatus according to claim 1, wherein the foreign-matter removing operation includes the intermittent operation and the reverse-rotating operation, and the operation controller is configured to cause the impeller to perform the intermittent operation and the reverse-rotating operation in the order of the intermittent operation and the reverse-rotating operation.

3. The pump apparatus according to claim 1, wherein:
the foreign-matter removing operation includes the reverse-rotating operation; and
the reverse-rotating operation includes a first reverse-rotating operation that rotates the impeller in the reverse direction in a first acceleration pattern and a second reverse-rotating operation that rotates the impeller in the reverse direction in a second acceleration pattern.

4. The pump apparatus according to claim 3, wherein the operation controller is configured to cause the impeller to perform the second reverse-rotating operation when a measured value of the current in the first reverse-rotating operation exceeds a threshold value.

5. The pump apparatus according to claim 3, wherein:
the first acceleration pattern is an acceleration pattern for speeding up the impeller at a constant acceleration; and
the second acceleration pattern is an acceleration pattern for speeding up the impeller while changing an acceleration of the impeller.

6. A pump apparatus comprising:
an impeller;
an electric motor configured to rotate the impeller;
an inverter configured to drive the electric motor;
a current measuring device configured to measure a current supplied to the electric motor; and
an operation controller configured to instruct the inverter to cause the impeller to perform a foreign-matter removing operation, the foreign-matter removing operation including a first reverse-rotating operation that rotates the impeller in a reverse direction in a first acceleration pattern and a second reverse-rotating operation that rotates the impeller in the reverse direction in a second acceleration pattern.

7. The pump apparatus according to claim 6, wherein the operation controller is configured to cause the impeller to perform the second reverse-rotating operation when a measured value of the current in the first reverse-rotating operation exceeds a threshold value.

8. The pump apparatus according to claim 6, wherein:
the first acceleration pattern is an acceleration pattern for speeding up the impeller at a constant acceleration; and
the second acceleration pattern is an acceleration pattern for speeding up the impeller while changing an acceleration of the impeller.
